(19) United States
(12) Patent Application Publication
(10) Pub. No.: US 2002/0190911 A1
(43) Pub. Date: Dec. 19, 2002

(54) Multimode horn antenna

(75) Inventor: Thierry Judasz, Ramonville (FR)

Correspondence Address: SUGHRUE MION, PLLC, 2100 Pennsylvania Avenue, NW, Washington, DC, 20037-3213, US

(73) Assignee: ALCATEL

(21) Appl. No.: 10/167,473

(22) Filed: Jun. 13, 2002

(30) Foreign Application Priority Data
Jun. 14, 2001 (EP) 01 401 552.3

(51) Int. Cl. H01Q 13/00

(52) U.S. Cl. 343/786

(57) ABSTRACT

The horn (11) comprises a plurality of transition steps can also be provided to increase the control of amplitude and phase content of the TE11 and TM11 modes at the output of the corn horn mouth (17) and suppress the unwanted TE12 mode. This control of the mode content provides for minimizing the length of the multimode horn antenna for a desired aperture size at the desired operational bandwidth, and provide low sidelobes and low cross-polarization, over a relatively wide bandwidth, with high electrical efficiency.

### OBJECT OF THE INVENTION

The present invention relates to multimode feed horn antennas, widely used for communication purposes. More particularly, but not exclusively, this invention relates to a multimode feed horn antenna for use in a multiple mode horn antenna system to provide beam radiation patterns that have substantially equal E-plane and H-plane beamwidths over the operating frequency band of a signal, low cross polarisation, low side lobes and high electrical efficiency.

### STATE OF THE ART

It is known the use of conical feed horns for radiating electromagnetic energy from a waveguide into free space, to produce beams having low sidelobes and equal E- and H-plane beamwidths.

A number of proposals have been made for producing these desirable characteristics in a horn. All of these approaches, however, have had certain drawbacks, such as limitation to narrow bandwidths, high dissipation or reflection losses, low power capabilities, limitation to particular polarisation, cost of fabrication, or complexity.

U.S. Pat. No. 4,792,814, “Conical Horn Antenna Applicable to Plural Modes of Electromagnetic Waves”, is incorporated herein by reference; it discloses a conical horn antenna which is composed of a feed waveguide, a desired mode of electromagnetic wave generating portion and a conical horn. The desired mode of electromagnetic wave generating portion comprises first and second tapered waveguides, first and second straight cylindrical waveguides.

These approximately correspond to those of the conventional horn antennas, provided their inside diameters are determined so that dominant modes of electromagnetic waves belonging to low and high frequency bands are fed to the feed waveguide.

The dominant modes of electromagnetic waves in both frequency bands and only TM11 mode electromagnetic wave in the high frequency band are propagated to the first cylindrical waveguide and so that TE12 mode and TM11 mode of electromagnetic waves in the high and low frequency bands, as well as the dominant modes of electromagnetic waves in both frequency bands and TM11 mode of electromagnetic wave in the high frequency band, are propagated to the second straight cylindrical waveguide.

As a result, by suitably selecting the value of inside diameter for each the straight cylindrical waveguide, one can obtain an electromagnetic wave with some control of the modes, which are propagated towards the flare.

### CHARACTERISATION OF THE INVENTION

The technical problems mentioned above are resolved by the invention by constituting a multimode horn antenna for transmitting a beam radiation pattern over a frequency transmit band of a signal, having an input transmission line part, a horn part comprising a first flare section, a first straight cylindrical waveguide, a second flare section, a second straight cylindrical waveguide; and a third flare section.

The horn part is adapted to permit transmission of electromagnetic waves of TE11 mode and TM11 mode and is adapted to suppress the propagation of an electromagnetic wave of TE12 mode. The multimode horn antenna is a compact, lightweight antenna feed horn that provides substantially equal E plane and H-plane beamwidths, low cross-polarisation and low side lobes, but has a higher useful bandwidth than other feed horns known in the art.

The horn is made of conventional feed horn materials, such as aluminium, for example, to make it lightweight and uniform in structure. The wall thickness of the horn is suitable to withstand the vibrations during launch in space environment. It has low cost and lightweight. The cross-sectional dimensions and diameters of the various sections of the horn would be designed for the particular antenna array, signal frequency, and coverage area desired for a particular communications network.

The horn part comprises a plurality of transition steps, which are made to control exactly the modal content at the output of the horn. This control of the mode content minimises the length of the multimode horn antenna for a desired aperture size at the desired operational bandwidth, and provide low side lobes and low cross-polarisation of the signal, in a relatively wide bandwidth.

A precise control of the TE11 and TM11 modes content as well as suppression of the TE12 mode provides the desired performance. Other modes have very low content. This allows obtaining the desired performance for high gain horn, up to 4 wavelengths in aperture or more, over up to 10% bandwidth or more, with high electrical efficiency. Typically 85% over 5% BW and 80% over 10% BW.

### BRIEF DESCRIPTION OF THE DRAWINGS

A more detailed explanation of the invention is given in the following description based on the attached drawings in which:

FIG. 1 shows a side plan view of a multimode horn antenna, according to an embodiment of the present invention,

FIG. 2 shows a side plan view of a multimode horn antenna, according to other embodiment of the present invention, and

FIG. 3 shows a radiation pattern of the invention.

### DESCRIPTION OF THE INVENTION

The usable bandwidth related to the content of the propagation modes of a signal, and determined by the phase orientation of the modes in that bandwidth. These propagation modes include the transverse electric TE modes where the electric field lines are in the transverse plane of wave propagation, and the transverse magnetic TM modes where the magnetic field lines are in the transverse plane of wave propagation. The orientation of the electric and magnetic fields in the various TE and TM modes defines the mode content of the signal.

An antenna has transmission capabilities for transmitting a signal having a frequency consistent with a communications network, such as the Ka frequency bandwidth, but can be used for any applicable frequency bandwidth, both commercial and military, including the Ka-band.

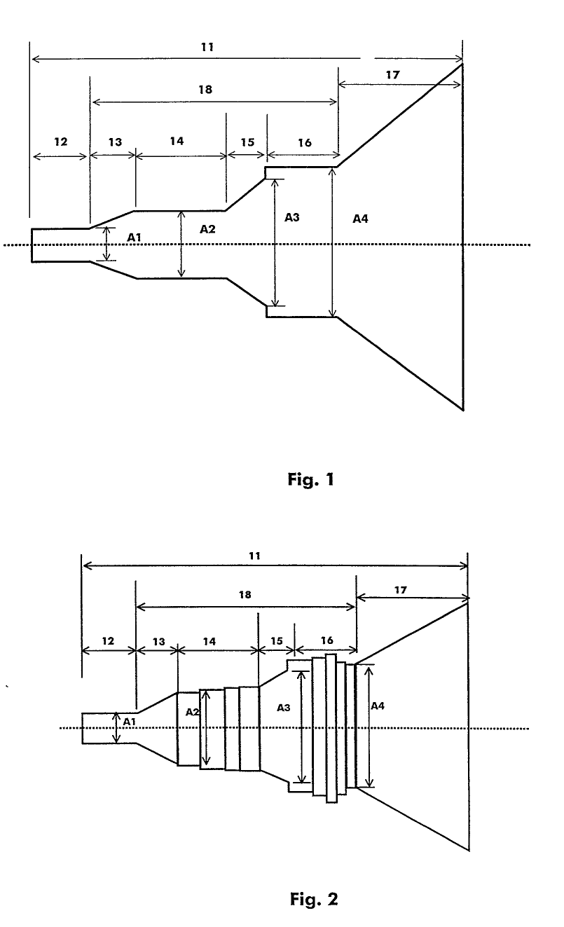

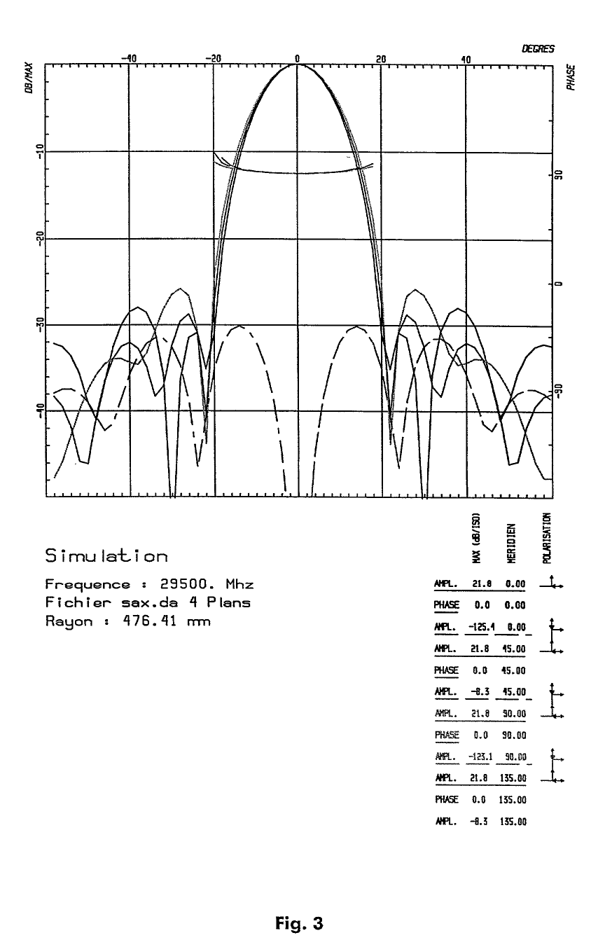

Referring to FIG. 1, a multimode horn antenna 11 embodying the present invention is shown. The horn antenna 11 forms a part of an antenna system, which includes signal generating and receiving means, not shown.

In this embodiment, the horn antenna 11 includes an input transmission line part 12 in the form of a straight waveguide, a first flare section with angle 13, a first plurality or series of steps designated by the reference numeral 14, a second flare section with angle 15, a second plurality or series of steps designated by the reference numeral 16 and a third flare section or conical horn 17.

The first series of steps (discontinuities) 14 is proportioned to control electromagnetic wave propagation in TE11 and TM11 mode content over a wide bandwidth. Typically there are 5 steps or more, shown in FIG. 2.

Thus, a horn part 18 consists of the first flare section 13, the first steps 14, the second flare section 15 and the second steps 16 joined to each other in end to end relationship to form flare type horn. This horn part 18 is adapted to control the content of TE11 and TM11 modes and to suppress other modes, including undesired TE12 mode. The waveguide 12 is proportioned to support the dominant mode.

The input end of the first flare section 13 is joined to the output end of the straight waveguide 12. The first flare section 13 may be considered as connecting means between the waveguide 12 and remain of the horn part 18 of the antenna 11.

Each flare section has a flare angle θ which may be defined as the angle formed, by the sides of the section with a central axis of symmetry of the horn antenna 11.

As a result, the horn part 18 changes form with discontinuities, namely, it includes a plurality of transition steps that provide effective control of the mode content of the signal to generate substantially equal E-plane and H-plan beamwidths, with low cross-polarisation and low side lobes.

The output end of the waveguide 12 matches the input dimension of the horn part 18. The first flare section 13 has an input dimension A1 and a positive flare angle θ1. The first straight cylindrical waveguide 14 has a cross-sectional dimension A2 equal to the output dimension of the first flare section 13, and a flare angle θ2 equal to zero.

The second flare section 15 has a cross-sectional dimension A3 greater than A2 and a flare angle θ3. The second straight cylindrical waveguide 16 has an input dimension A4 greater than A3, and a flare angle θ4 equal to zero.

The input end of the third flare section or conical horn 17 matches the output dimension of the second straight cylindrical waveguide 16.

In order to provide the transmission of higher propagation modes, such as the TM11 mode, with proper content, a discontinuity must be provided within the horn part 18 that expands the propagation diameter of the first straight cylindrical 14. The transition step A2 provides such discontinuity.

The actual discontinuities to be provided for proper TM11 mode content can be calculated based on the frequency or wavelength λ of the signal.

The larger transition steps A3 and A4 provide the discontinuity and the diameter required to prevent propagation of the TE12 mode for the desirable signal transmission of the frequency band of interest.

The combination of the two transition steps A1 and A2 allows the designer of the horn antenna 11 to optimise the transition into the higher order TM11 mode, and provide the necessary phase and amplitude relationships between the TE11 and TM11 modes for increased bandwidth.

Two transition steps (or more) allow the generations of the higher order TM11 so that the E-plane bandwidth and the H-plane bandwidth are about the same. The transition steps and a phase section control provide the proper power ratio and phase difference between the useful TE11 mode and TM11 mode over 10% or greater bandwidth.

Referring now to FIG. 2, other embodiment of the present invention is shown. While in the first embodiment the horn part 18 has two straight cylindrical waveguides 14 and 16, in the second embodiment the horn part 18 comprises four and five straight cylindrical waveguides; joined to each other in end to end relationship to form flare type horn.

The input dimension of the conical horn 17 matches the output dimension of last cylindrical section 16. The plurality of steps 14 or A2 allows increased bandwidth on the same principle as a filter.

The multiple transition steps A2 and A4 give the flexibility to provide proper phase and amplitude content for the TE11 and TM11 modes over a wide bandwidth. The inside diameters of the steps of section 16 are set at a size which permits transmission of electromagnetic waves of TE11 and TM11 modes but cancels the presence of TE12 mode over a relatively wide bandwidth. As a result, several steps are set up after of the second flare section 15 for suppressing completely the undesirable TE12 mode electromagnetic wave.

The combination of the transition steps A2 and A4 provide the discontinuity necessary for the generation the higher order TM11 mode, and the flexibility to design the dimensions to provide an increased optimal bandwidth. By providing multiple transition steps, the feed horn antenna 11 of this invention provides more control for the mode content of the signal.

Additional transmission steps can also be provided to further increase the phase control of the TE11 and TM11 modes at the input of the conical horn 17, and provide increased control of the mode content.

As a result, the horn antenna 11 provides a useful bandwidth on the order of 10%-15%. For example, 5% with 85% electrical efficiency or 10% with 80% efficiency. This control of the mode content provides means for minimising the length of the feed horn antenna 11 for a desired aperture size at the desired operational bandwidth, and provide low sidelobes and low cross-polarisation of the signal. Such horn can have aperture size of 4 wavelengths or more. Because of the simple design and excellent mode control the VSWR is kept low, typically 1.15 or better. Its high electrical efficiency allows using such horns in multimedia multibeam antennas or in multifeed antennas.

1. Multimode horn antenna for transmitting a beam radiation patterns over a frequency transmit band of a signal; includes an input transmission line part (12), a horn part (18) having a first flare section (13), a first straight cylindrical waveguide (14), a second flare section (15), a second straight cylindrical waveguide (16); a third flare section (17); characterised in that the horn part (18) is adapted to permit transmission of electromagnetic waves of TE11 mode and TM11 mode and is adapted to suppress the propagation of an electromagnetic wave of TE12 mode through the second straight cylindrical waveguide (16).

2. Multimode horn antenna according to claim 1; characterised in that the first straight cylindrical waveguide (14) includes a predetermined number of discontinuities to control the propagation of the electromagnetic wave of TM11 mode.

3. Multimode horn antenna according to claim 2; characterised in that the predetermined number of discontinuities is equal or greater than 5.

4. Multimode horn antenna according to claim 1; characterised in that the second straight cylindrical waveguide (16) includes a predetermined number of discontinuities to suppress the propagation of the electromagnetic wave of TE12 mode.

5. Multimode horn antenna according to claim 4; characterised in that in that the predetermined number of discontinuities is equal or higher than 5.
